(19) United States
(12) Patent Application Publication
(10) Pub. No.: US 2016/0064732 A1
(43) Pub. Date: Mar. 3, 2016

(54) METHODS FOR THE PREPARATION OF LITHIUM TITANATE

(71) Applicant: JOHNSON MATTHEY PUBLIC LIMITED COMPANY, London (GB)

(72) Inventor: Mark Patrick COPLEY, Oxford (GB)

(21) Appl. No.: 14/784,399

(22) PCT Filed: Apr. 15, 2014
(86) PCT No.: PCT/GB2014/051171

§ 371 Date: Oct. 14, 2015

(30) Foreign Application Priority Data
Apr. 15, 2013 (GB) 1306814.3

(51) Int. Cl. H01M 4/485; H01M 10/0525; H01M 10/0562; H01M 4/04; H01M 8/10; H01M 12/08; H01M 4/88; C01G 23/00; H01M 4/90

(52) U.S. Cl. CPC H01M 4/485; C01G 23/005; H01M 10/0525; H01M 10/0562; H01M 4/9016; H01M 8/1016; H01M 12/08; H01M 4/8875; H01M 4/0471; H01M 4/8825; C01P 2006/40; C01P 2002/54; C01P 2006/12; H01M 2220/20; H01M 2220/30

(57) ABSTRACT

Lithium titanate materials are suitable for use in electrochemical applications, and methods for their production. The materials are particularly suitable as electrode (e.g. anode) materials, and as lithium ion conducting membranes. Accordingly, the materials may find particular utility as battery materials, e.g. in lithium ion and/or lithium air batteries. In particular, there is provided a method for the preparation of lithium titanate, wherein a precursor mixture including a solvent, a lithium precursor and a titanium precursor is subjected to flame spray pyrolysis to produce lithium titanate particles. The present inventors have found that it is possible to significantly reduce the formation of the rutile impurity phase by controlling the flame spray pyrolysis process.

### FIELD OF THE INVENTION

The present invention relates to lithium titanate materials suitable for use in electrochemical applications, and methods for their production. The materials of the present invention are particularly suitable as electrode (e.g. anode) materials, and as lithium ion conducting membranes. Accordingly, the materials of the present invention may find particular utility as battery materials, e.g. in lithium ion and/or lithium air batteries.

### BACKGROUND OF THE INVENTION

Lithium ion batteries are a type of rechargeable battery commonly used in consumer electronics. They are popular since they offer both high energy and power densities. Accordingly, they are also a promising candidate as batteries for fully electric vehicles.

Typically, lithium ion batteries have employed graphite as the anode material. Graphite has been popular, since it has a high specific capacity, and allows easy intercalation and deintercalation of lithium ions during charge and discharge. However, recent development work has focussed on providing alternative anode materials.

Lithium titanate (LTO; Li₄Ti₅O₁₂) is currently considered to be a promising material to replace graphite as anode material for lithium ion batteries. LTO has a significantly higher lithium insertion/deinsertion potential than graphite, which leads to certain advantages such as avoiding the problems of dendrite formation, metallic lithium plating and electrolyte decomposition (1, 2, 3). Furthermore, LTO has excellent cycling stability, as there is very little volume change on insertion/deinstertion of lithium (3).

However, LTO typically has a higher discharge potential than graphite, and accordingly this restricts the energy density of batteries comprising LTO as anode material. Additionally, since LTO has a limited specific capacity of about 175 mAh g⁻¹, it is typically not the preferred material for high energy applications.

Accordingly, research has focussed on developing LTO to make it suitable for high power applications, where high charge and discharge rates are important. One approach for increasing the charge and discharge rates is by reducing LTO particle size (4, 5, 6). This allows increased electrode/electrolyte contact area, and shorter diffusion pathways for electrons and lithium ions (7, 8)

Reference 9 describes the synthesis of nanoparticulate LTO by flame spray pyrolysis, and demonstrates that nano-sized LTO has a significantly increased specific capacity compared with micro-sized LTO. However, the nano-sized LTO synthesised in this paper had several phase impurities, including rutile TiO₂. As explained in Reference 9, the presence of rutile TiO₂ leads to a high irreversible capacity loss for the first cycle, believed to arise from irreversible structural changes which occur on initial lithiation. Accordingly, reduction of the occurrence of the rutile phase is desirable.

Reference 10 describes the synthesis of silver- and copper-doped LTO nanoparticles using flame spray pyrolysis. The precursors used are lithium acetylacetonate and titanium tetraisopropoxide, in a solvent mixture of toluene and 2-ethyl hexanoic acid. The transition metal precursors were silver 2-ethyl hexanoate and copper 2-ethyl hexanoate. Reference 10 reports that the two transition metal dopants behave very differently; the silver forms a separate phase of metallic silver particles, while the copper dopant reacts with the LTO to form a double spinel phase.

Recent development work in the battery field has also focussed on materials which conduct lithium ions, for example for use as lithium ion conducting membranes, e.g. in lithium air batteries.

### SUMMARY OF THE INVENTION

There remains a need for improved battery materials (e.g. lithium ion battery materials and lithium air battery materials), and for improved methods for their manufacture. In particular, there remains a need for battery materials with improved phase purity, and/or which exhibit improved performance properties such as specific capacity, cycling stability and lithium ion conductivity.

Nanoparticulate lithium titanate materials can advantageously be made by flame spray pyrolysis. Accordingly, at a general level the present invention provides a method for the preparation of lithium titanate, wherein a precursor mixture comprising a solvent, a lithium precursor and a titanium precursor is subjected to flame spray pyrolysis to produce lithium titanate particles. The present inventors have found that it is possible to significantly reduce the formation of the rutile impurity phase by controlling the flame spray pyrolysis process.

In particular, the present inventors have found that the properties of the lithium precursor can affect the degree of formation of the rutile impurity phase, as demonstrated in the examples. Accordingly, in a first preferred aspect, the present invention provides a method for the preparation of lithium titanate, wherein a precursor mixture comprising a solvent, a lithium precursor and a titanium precursor is subjected to flame spray pyrolysis to produce lithium titanate particles, wherein the lithium precursor has a melting point of 200° C. or less.

As demonstrated in the Examples, where a lithium precursor with a higher melting point (such as lithium hydroxide) is used, the resulting lithium titanate particles include a higher proportion of rutile phase. In contrast, where a lithium precursor with a melting point of 200° C. or less is used, such as lithium acetate, significantly less rutile phase is formed.

The present inventors have also found that the molar ratio of lithium to titanium provided in the precursor mixture can affect the formation of phases in the lithium titanate material produced. The present inventors have realised that it may be undesirable that lithium is provided in excess, as lithium carbonate phase may be formed and increased rutile formation may be observed. Similarly, as demonstrated in the Examples, the present inventors have surprisingly found that even where the lithium to titanium ratio is stoichiometric, more rutile phase is produced than when titanium is provided in excess. A stoichiometric ratio for lithium to titanium for forming lithium titanate (Li₄Ti₅O₁₂) is 1:1.25. Accordingly, in a second preferred aspect, the present invention provides a method for the preparation of lithium titanate, wherein a precursor mixture comprising a solvent, a lithium precursor and a titanium precursor is subjected to flame spray pyrolysis to produce lithium titanate particles, wherein the lithium to titanium molar ratio in the precursor mixture is at least 1:1.3.

The present inventors have further found that including a dopant can provide lithium titanate with improved properties. Accordingly, one or more dopant precursors may be provided (e.g. added to the precursor mixture) in order to produce doped lithium titanate particles. Accordingly, in a third preferred aspect the present invention provides a method for the preparation of lithium titanate, wherein a precursor mixture comprising a solvent, a lithium precursor and a titanium precursor is subjected to flame spray pyrolysis to produce lithium titanate particles, wherein the precursor mixture comprises one or more dopant precursors. Preferably, the dopant is a metal dopant, such as a d or f block transition metal, or Group 13, 14 or 15 metal. Accordingly the dopant precursor may be an organometallic compound. Preferably, the dopant is one or more selected from Co, Sn, Cu, Al, V, Ag, Ta and Zn, most preferably Co or Sn. Alternatively, it will be understood that the lithium titanate material may be prepared without the addition of a dopant or dopant precursor.

The inclusion of a dopant precursor may additionally provide electrochemical benefits. Without wishing to be bound by theory, the present inventors consider that the dopant precursors can improve specific capacity of the battery, particularly where the dopant operates in the same or a comparable electrochemical window as LTO. Furthermore, LTO and simple oxide materials may exhibit failure after a relatively small number of charge/discharge cycles in a battery. Without wishing to be bound by theory, this is believed to be due to particle agglomeration. The present inventors consider that doping of the LTO lattice will reduce or avoid migration and agglomeration, due to the “freezing” effect of the dopant on the LTO lattice reducing migration mobility. Therefore, improved cycling stability is expected for doped LTO materials.

The present inventors consider that the methods disclosed herein make available for the first time high surface area lithium titanate nanoparticles doped with Co and/or Sn. Accordingly, in a further preferred aspect, the present invention provides doped lithium titanate particles having a surface area of at least 90 m²/g, wherein the dopant is Co and/or Sn. As the skilled person will readily understand, the surface area may be determined by the BET technique. In a still further preferred aspect, the present invention provides doped lithium titanate particles having a D50 particle size of less than 100 nm, more preferably less than 80 nm, where the size distribution is determined by number.

### BRIEF DESCRIPTION OF THE DRAWINGS

FIGS. 1 to 7 show results of x ray diffraction studies carried out on samples prepared in Example 1 below.

FIGS. 9 to 15 show results of x ray diffraction studies carried out on samples prepared in Example 2 below.

### DETAILED DESCRIPTION

Further preferred and/or optional features of the invention will now be set out. Any aspect of the invention may be combined with any other aspect of the invention, unless the context demands otherwise. Any of the preferred or optional features of any aspect may be combined, singly or in combination, with any aspect of the invention, unless the context demands otherwise.

In the methods of the present invention, the lithium precursor preferably has a melting point of 200° C. or less. More preferably, the lithium precursor has a melting point of 180° C. or less, 160° C. or less, 150° C. or less, 140° C. or less, 130° C. or less, 120° C. or less, 110° C. or less, 100° C. or less, 90° C. or less, 80° C. or less, 70° C. or less, or most preferably 60° C. or less. The lithium precursor may have, for example, a melting point of at least 10° C.

A particularly suitable lithium precursor is lithium acetate dihydrate, which has a melting point of approximately 50° C.

The skilled person is readily able to identify suitable lithium precursors for use in the methods of the invention. However, typically the lithium precursor will be a lithium organometallic compound, such as a lithium carboxylate or a lithium alkoxide. For example, lithium acetate is particularly suitable, such as hydrated lithium acetate (e.g. lithium acetate dihydrate). The skilled person will also readily understand that the melting point of a suitable lithium precursor may be altered by its crystalline form and/or degree of hydration.

Preferably the lithium precursor is soluble in alcohol, such as in methanol and/or ethanol.

The nature of the titanium precursor is not particularly limited in the present invention. However, it may be preferable that it has a melting point not more than 100° C. higher than the melting point of the lithium precursor. For example, it may be a melting point not more than 50° C. higher than the melting point of the lithium precursor, or it may have a melting point approximately equal to or less than that of the lithium precursor. Some suitable titanium precursors may be liquid at room temperature and pressure.

Without wishing to be bound by theory, the present inventors believe that it is preferable that the lithium and titanium precursor have broadly similar melting points, as this may lead to the titanium and lithium becoming available for reaction at similar points in the flame spray pyrolysis process thus reducing the formation of impurity phases. As demonstrated in the Examples, this can also help to produce high surface area material.

The titanium precursor may be a titanium coordination compound, for example having carboxylate and/or alkoxy ligands. For example, C₁ to C₁₅, or more preferably C₆ to C₁₀ carboxylate ligands may be particularly suitable. A particularly suitable titanium precursor is titanium 2-ethylhexanoate, which is liquid at room temperature and pressure. The titanium of the titanium precursor may be, for example, in oxidation state 4.

Preferably the titanium precursor is soluble in alcohol, such as in methanol and/or ethanol.

The methods of the present invention permit the production of doped lithium titanate materials. Accordingly, in the methods of the present invention, one or more dopant precursors may be provided in order to produce doped lithium titanate particles. For example, one or more dopant precursors may be added to the precursor mixture. Preferably, the dopant is a metal dopant. The dopant precursor may be an organometallic compound, such as a dopant coordination compound, for example having one or more alkoxy and/or carboxylate ligands, preferably carboxylate. Particularly suitable are metal acetate compounds.

Preferably the dopant precursor is soluble in alcohol, such as in methanol and/or ethanol.

Preferably, the dopant is one or more selected from Co, Sn, Cu, Al, V, Ag, Ta and Zn, most preferably Co or Sn.

The amount of dopant provided is not particularly limited. It may be preferable that at least 0.1 wt % is provided, such as at least 0.5 wt %, at least 1 wt %, at least 2 wt %, at least 3 wt %, at least 4 wt % or at least 5 wt % on an oxide basis. The amount of dopant may be 25 wt % or less, more preferably 20 wt % or less, 17 wt % or less, 15 wt % or less, 14 wt % or less, 13 wt % or less, 12 wt % or less, 11 wt % or less or 10 wt % or less on an oxide basis. The weight percentage of dopant may conveniently be calculated based on the amount of dopant precursor provided, assuming 100% yield.

The present inventors have found that the precursors employed in the methods of the present invention may very conveniently be supplied in a simple solvent system. In contrast, a more complicated blend of solvents has typically been required previously. Preferably, the solvent comprises alcohol, and preferably at least 50% v/v of the solvent is alcohol. More preferably, at least 60% v/v, at least 70% v/v, at least 80% v/v, at least 90% v/v or at least 95% v/v of the solvent is alcohol. The solvent may consist essentially of alcohol.

Suitable alcohols include C₁ to C₁₀ alcohols or mixtures thereof, more preferably C₁ to C₅ or C₁ to C₃ alcohols or mixtures thereof. Particularly preferred are methanol, ethanol and mixtures thereof. As noted above, preferably the lithium, titanium and/or dopant precursors are soluble in alcohol.

As explained in the examples sections below, and without wishing to be bound by theory, the present inventors consider that the enthalpy of combustion of the solvent or solvent mixture used in the flame spray pyrolysis may affect the particle size and surface area of the particles produced. Accordingly, preferably the solvent has an enthalpy of combustion less than 3000 kJ/mol, less than 2500 kJ/mol, less than 2000 kJ/mol, less than 1900 kJ/mol, less than 1800 kJ/mol, less than 1700 kJ/mol, less than 1600 kJ/mol, less than 1500 kJ/mol, or more preferably less than 1400 kJ/mol. In some embodiments, it may be preferable that the solvent has an enthalpy of combustion less than 1300 kJ/mol, less than 1200 kJ/mol, less than 1100 kJ/mol, or less than 1000 kJ/mol.

As demonstrated below, the molar ratio of lithium to titanium provided in the precursor mixture can affect the formation of phases in the lithium titanate material produced. A stoichiometric ratio for lithium to titanium for forming lithium titanate (Li₄Ti₅O₁₂) is 1:1.25.

The present inventors have realised that it may be undesirable that lithium is provided in excess, a lithium carbonate phase may be formed and increased rutile formation may be observed. Similarly, the present inventors have surprisingly found that even where the lithium to titanium ratio is stoichiometric, more rutile phase is produced than when titanium is provided in excess.

Accordingly, preferably the lithium to titanium molar ratio in the precursor mixture is stoichiometric or titanium is in excess. For example, the lithium to titanium molar ratio in the precursor mixture may be at least 1:1.25, more preferably at least 1:1.3, 1:1.35, 1:1.4, 1:1.45 or 1:1.5. The lithium to titanium molar ratio in the precursor solution may be, for example, 1:2 or less, 1:1.9 or less, 1:1.8 or less, 1:1.75 or less, 1:1.7 or less, 1:1.65 or less, 1:1.6 or less or 1:1.55 or less.

As demonstrated in the examples below, where dopant is added, the formation of rutile phase may be suppressed. Accordingly, the present inventors consider that there is less need to provide titania in excess where dopant is provided. The preferred ratios given above apply equally where a dopant is added. However, where dopant is provided (i.e. where a dopant precursor is provided), the lithium to titanium molar ratio may be at least 1:1.15 or 1:1.2.

It will be understood that the lithium titanate particles formed by the methods of the present invention are typically nanoparticles. Typically, the lithium titanate particles have a BET surface area of at least 90 m²/α. more preferably at least 100 m²/α. at least 105 m²/α. at least 110 m²/g, at least 115 m²/g, or at least 120 m²/g. The BET surface area may be determined using N₂ physisorption with degassing at 150° C. before measurement.

Preferably the lithium titanate particles formed by the present invention have a D50 particle size of less than 100 nm, more preferably less than 90 nm, less than 85 nm, less than 80 nm, less than 75 nm, or less than 70 nm, less than 90 nm, where the size distribution is optionally determined by number. For example, the D50 particle size may be determined using dynamic light scattering, e.g. using a Zetasizer Nano ZS instrument.

Preferably, the lithium titanate particles contain less than 9 wt % of the rutile phase, more preferably less than 8 wt %, less than 7 wt %, or less than 6 wt % of the rutile phase. Preferably, the lithium titanate particles include at least 75 wt % lithium titanate, more preferably at least 80 wt %, at least 82 wt %, at least 84 wt %, at least 85 wt % or at least 86 wt % lithium titanate. As the skilled person will readily appreciate, the wt % may be determined e.g. by carrying out a Reitveld Refinement on XRD data. The conditions given below in the Examples may be employed. The skilled person will be aware that this technique provides a wt % with respect to the crystalline parts of the sample. However, transition electron microscope images of the samples produced by the methods of the present invention reveal a high degree of crystallinity.

The methods of the present invention may further comprise forming the lithium titanate particles produced by the methods of the present invention into an electrode comprising lithium titanate. A suitable method for forming a lithium titanate electrode is described in Reference 9, which is hereby incorporated by reference in its entirety and in particular for the purpose of describing the formation of electrodes comprising lithium titanate.

The electrode may be incorporated in to a battery, such as a lithium ion battery. Accordingly, the methods of the present invention may further comprise assembling a battery comprising the electrode.

Similarly, the methods of the present invention may further comprise forming the lithium titanate particles into a membrane, such as a lithium ion conducting membrane. The membrane may be incorporated into a battery, such as a lithium air battery. Accordingly, the methods of the present invention may further comprise assembling a battery comprising the membrane.

It will be understood that the present invention provides, in a further preferred aspect, a method of manufacturing an electrode, comprising forming lithium titanate particles into an electrode. Similarly, in a further preferred aspect, the present invention provides a method of manufacturing a membrane comprising forming lithium titanate particles into a membrane, such as a lithium ion conducting membrane. The lithium titanate particles may be produced according to the methods of the present invention, and/or may be doped lithium titanate particles according to the present invention.

The present invention provides in a still further aspect a method of manufacturing a battery, comprising assembling a battery comprising manufacturing an electrode and/or a membrane as described and defined above, and assembling a battery comprising the electrode and/or membrane.

(It will be understood that where lithium titanate and lithium titanate are referred to herein, doped lithium titanate is intended to be included as the context allows.)

The present invention will now be further described with reference to the following examples, which are provided for illustrative purposes only and are not intended to limit the scope of the invention.

### EXAMPLES

### Example 1

### Preparation of Lithium Titanate Materials

Lithium titanate samples were prepared by flame spray pyrolysis. For each sample, the titanium precursor was titanium 2-ethylhexanoate. In each case, the precursor feedstock was prepared by adding a predissolved lithium precursor solution (0.18M lithium concentration) to the titanium precursor solution. All of the precursor solutions were prepared at room temperature, with stirring.

The flame spray pyrolysis conditions used for each sample are set out below in Table 1.

TABLE 1

| | | |
|---|---|---|
| Flame CH₄ | 1.5 | L/min |
| Flame O₂ | 3.2 | L/min |
| Sheath O₂ | 5 | L/min |
| Dispersion O₂ | 5 | L/min |
| Pressure drop | 1.5 | bar |
| Feed rate | 7.5 | ml/min |

In producing the samples, the lithium precursor, solvent mix and lithium to titanium molar ratio were varied, as set out in Table 2 below.

TABLE 2

| Sample | | | |
|---|---|---|---|
| No. | Lithium Precursor | Li:Ti Ratio | Solvent |
| 1 | Li acetate dihydrate | 1:1.5 | MeOH |
| 2 | Li acetate dihydrate | 1:1.5 | EtOH |
| 3 | Li acetate dihydrate | 1:1.25 | MeOH |
| 4 | Li acetate dihydrate | 1:1.25 | EtOH |
| 5 | Li acetate dihydrate | 1:1 | MeOH |
| 6 | Li hydroxide | 1:1.25 | Xylene, acetonitrile, |
| | | | acetic acid, EtOH |
| 7 | Li hydroxide | 1:1.5 | Xylene, acetonitrile, |
| | | | acetic acid, EtOH |

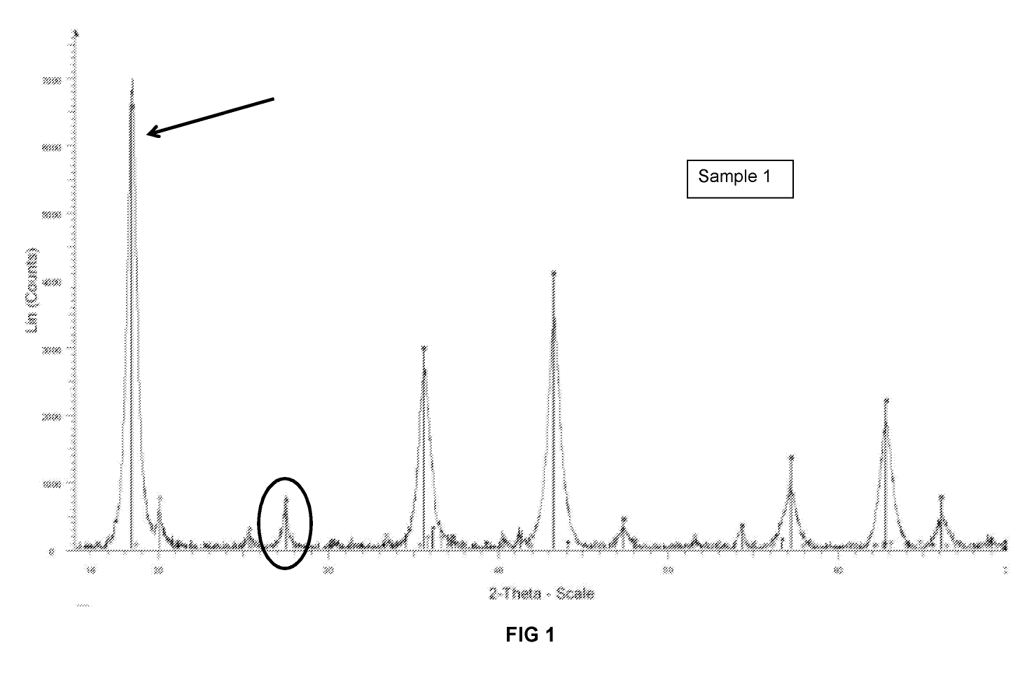

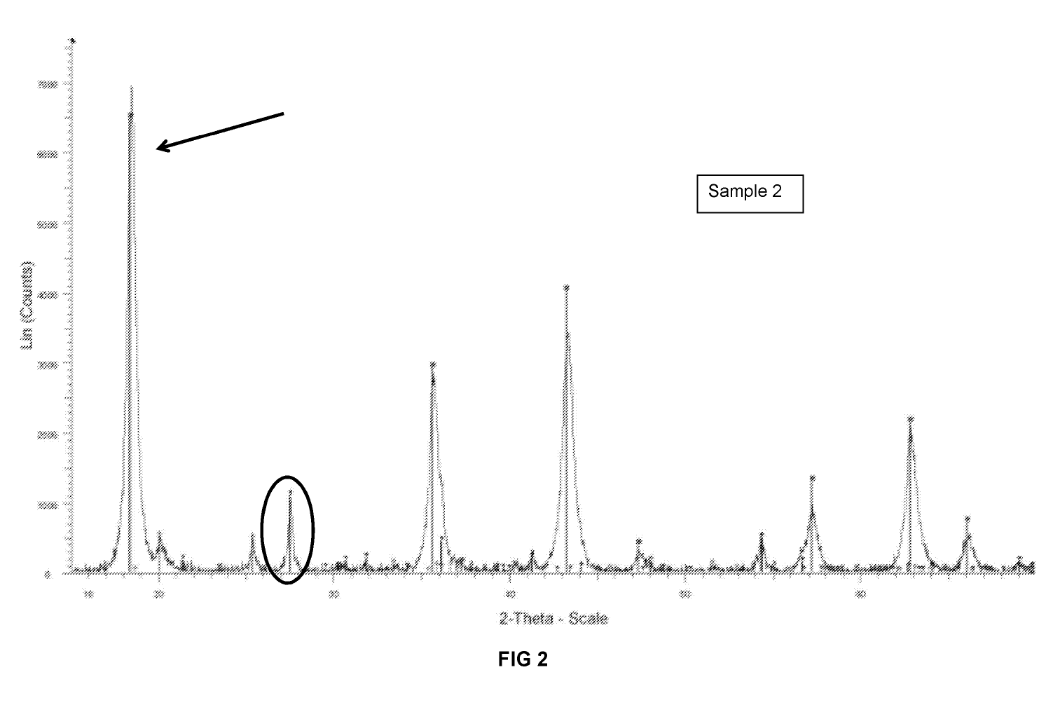

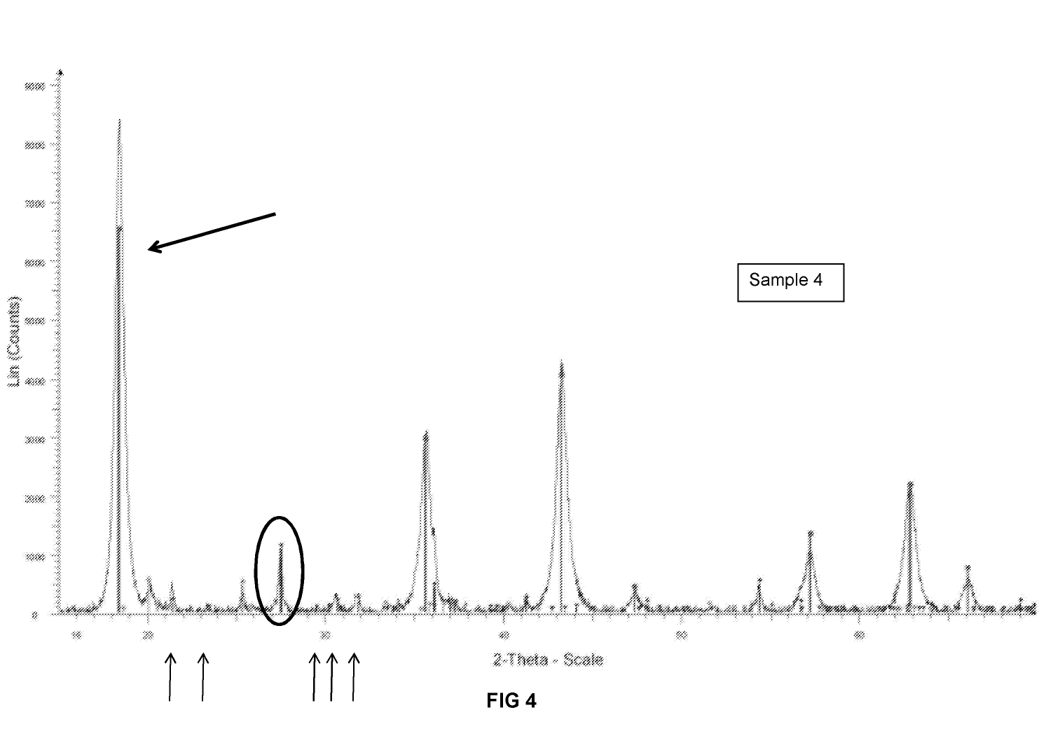

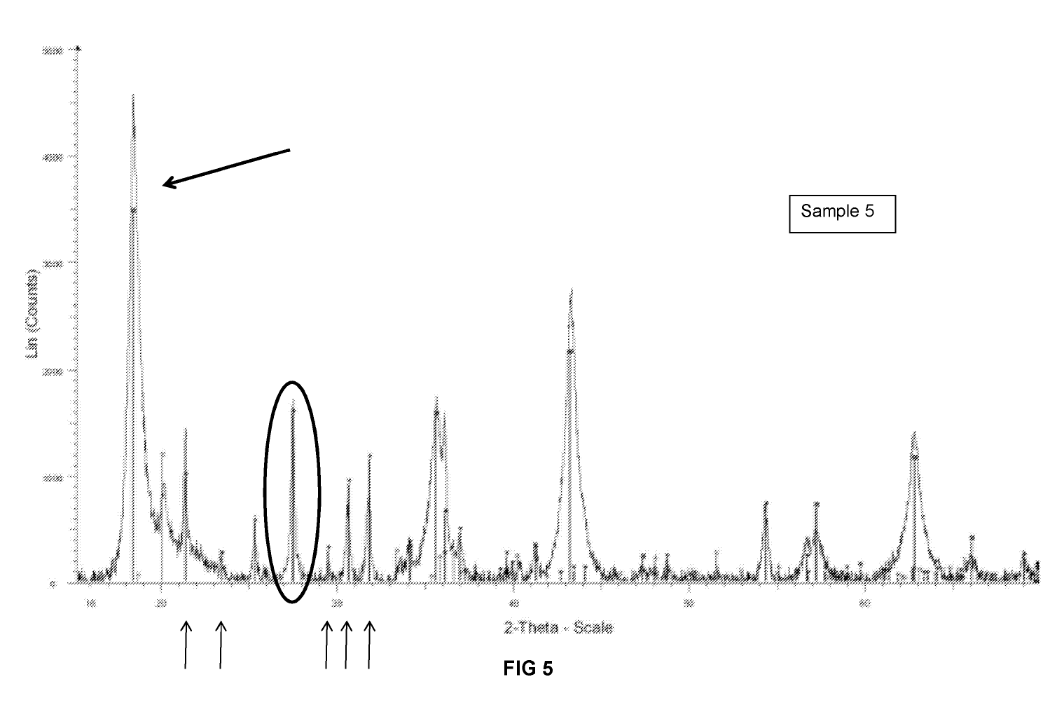

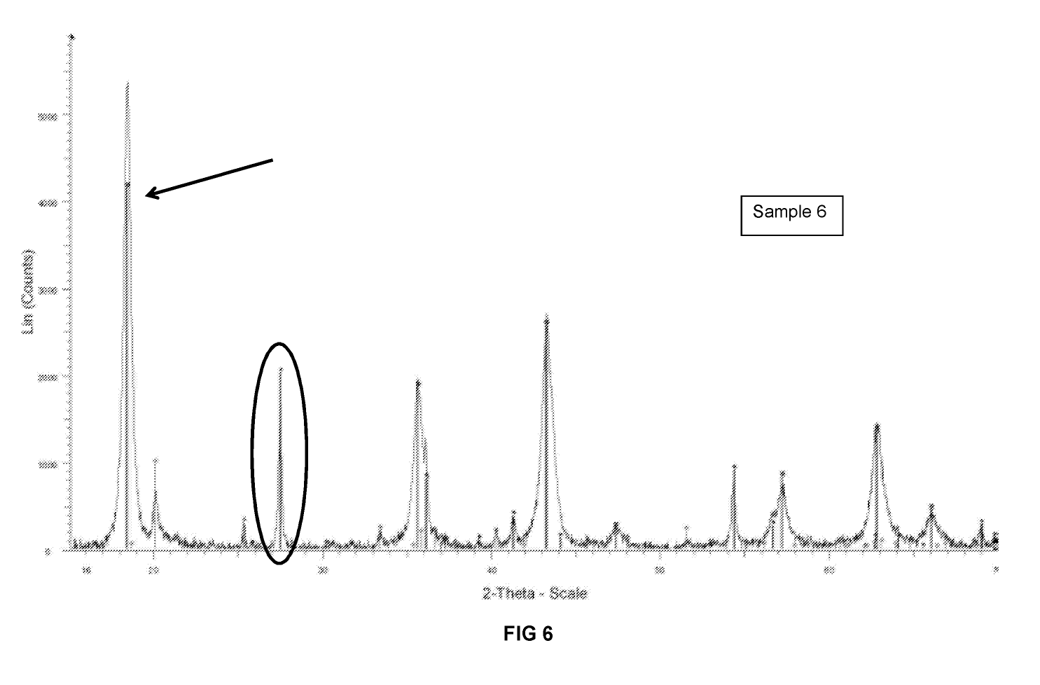

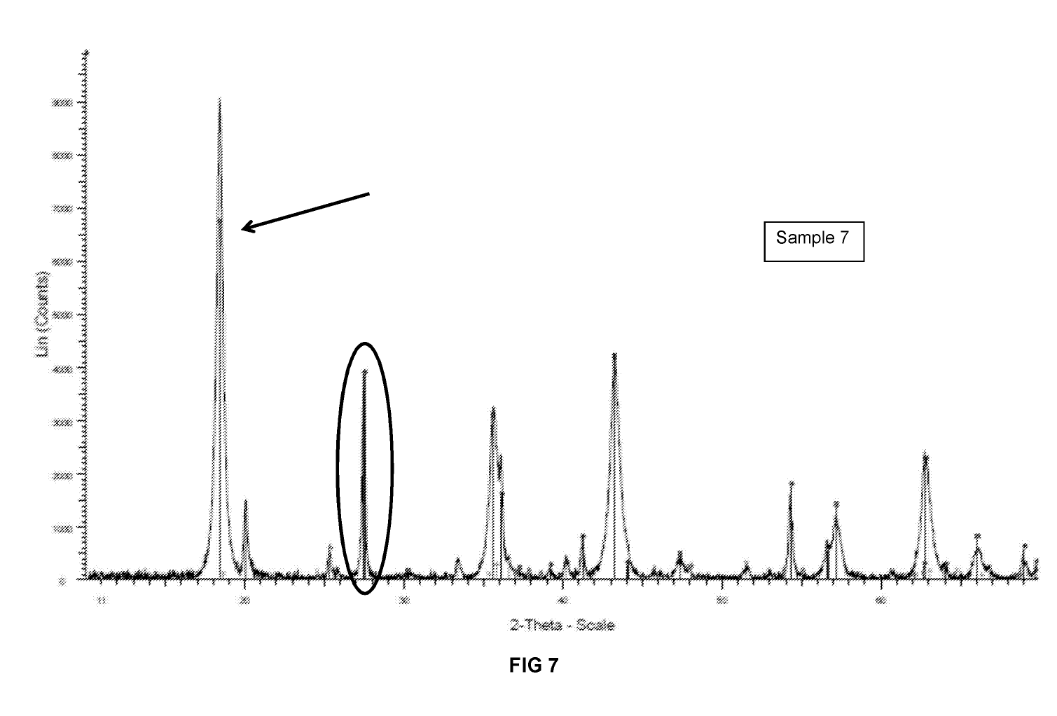

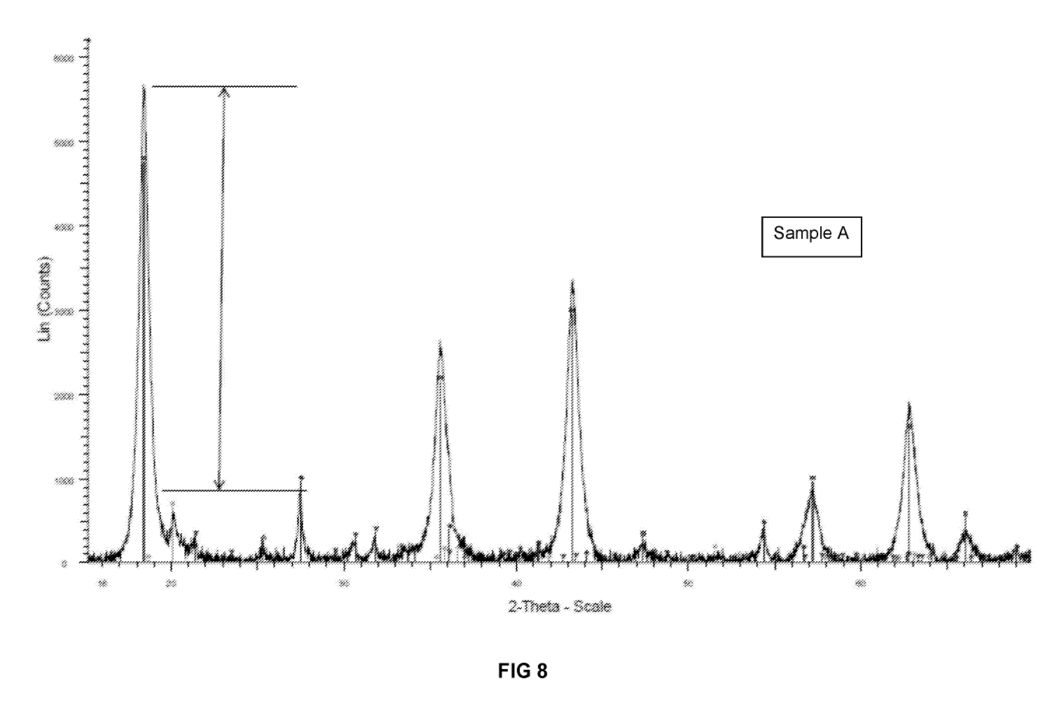

X ray diffraction was carried out on that samples produced to probe their composition. The results are shown in FIGS. 1 to 7. The wt % of rutile and lithium titanate was determined for Samples 1 and 6. For Sample 1, the rutile content was 5.55 wt %, and the lithium titanate content was 86.33 wt %. For Sample 6, the rutile content was 9.65 wt %, and the lithium titanate content was 83.35 wt %.

The wt % was determined using a Rietveld Refinement, with observed scattering fro each sample fitted using a full structural model for the phases (i) rutile TiO₂ and (ii) Li₄Ti₅O₁₂ in Fd-3m, a≈8.4 Å. The databases used were ICDD PDF Files: PDF-4, Release 2012, and COD (REV30738 2011.11.2.

Where measured, the surface area of each sample is given in Table 3 below. The surface area was determined using the BET method, with N2 physisorption. The samples were degassed at 150° C. before measurement.

TABLE 3

| | Surface Area/ |
|---|---|
| Sample No. | m²/g |
| 1 | 131.1 |
| 2 | 112.8 |
| 3 | 133.4 |
| 5 | 130.1 |
| 6 | 85.1 |
| 7 | 88.2 |

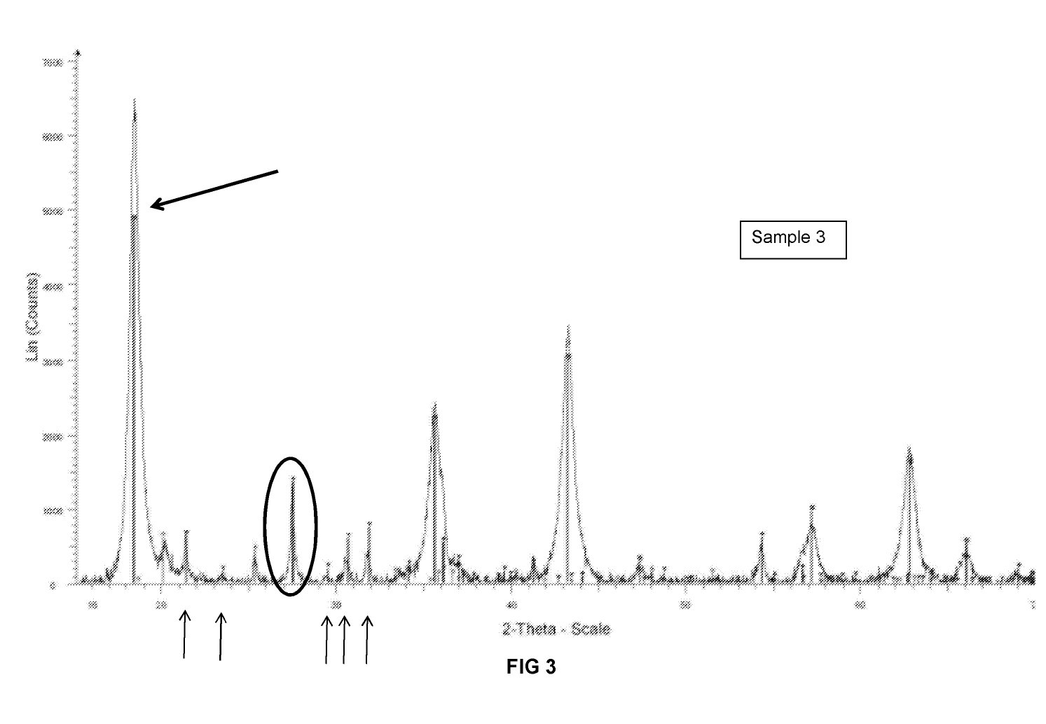

In each of FIGS. 1 to 7, one of the peaks associated with the lithium titanate phase is indicated with a heavy arrow, and one of the peaks associated with the rutile phase is circled. In FIGS. 3, 4 and 5, peaks corresponding to a lithium carbonate phase are indicated with light arrows below the x-axis.

It can clearly be seen from the peak heights in the figures that significantly less rutile is formed where lithium acetate is used as the precursor, rather than lithium hydroxide. Similarly, a reduction in the percentage of anatase formed was observed for the samples prepared using lithium acetate.

Without wishing to be bound by theory, the present inventors consider that this may occur due to the significantly lower melting point of lithium acetate compared with lithium hydroxide: about 50° C. compared with about 500° C. The present inventors consider that the using a lower melting point lithium precursor makes the lithium available for reaction more quickly, thus restricting the time available for formation of titanium oxide phases such as rutile and anatase. In particular, providing a lithium precursor with a broadly similar melting point to the melting point of the titanium precursor may be particularly advantageous. Titanium 2-ethylhexanoate used in the present examples is liquid at room temperature.

It can also be seen that where the Li:Ti ratio in the precursor feed is stoichiometric for lithium titanate formation (samples 3 and 4), or where lithium is provided in excess (sample 5), a lithium carbonate phase is also formed, with more carbonate formation where lithium is in excess. However, for samples 1 and 2, where titanium is provided in excess, no lithium carbonate is observed. Accordingly, it is advantageous to provide a precursor feed in which the Li:Ti ratio is stoichiometric or more preferably has titanium in excess.

The results given above in Table 3 also show that significantly higher surface areas are obtained where lithium acetate is used rather than lithium hydroxide. This is advantageous where these materials are employed as battery materials e.g. in lithium ion batteries, since it provides more surface for lithium intercalation, improving electrochemical performance.

Without wishing to be bound by theory, the present inventors consider that the observed increased surface area may be due to the use of methanol or ethanol as the solvent. These solvnets have a lower enthalpy of combustion than the solvent blend used for Samples 6 and 7, which leads to a lower product collection temperature. This is believed to provide a higher surface area powder.

The use of lithium acetate provides a further advantage, since it is soluble in alcohol so a simple solvent system may be employed. In contrast, a blend of four different solvents is required to dissolve lithium hydroxide and titanium 2-ethylhexanoate together.

### Example 2

### Preparation of Doped Lithium Titanate Materials

Doped lithium titanate samples were prepared by flame spray pyrolysis. For each sample, the titanium precursor was titanium 2-ethylhexanoate. In each case, the precursor feedstock was prepared by adding a predissolved lithium precursor solution (0.18M lithium concentration) to the titanium solution. The dopant precursor was added as a solid to the mixed lithium and titanium precursor solution, and the mixture stirred at room temperature. The lithium and titanate precursor solutions were each prepared at room temperature, with stirring.

In each sample, the lithium to titanium ratio was 1:1.25 (i.e. stoichiometric ratio). The dopant weight percent is the weight percent in the final product on an oxide basis, assuming 100% yield from the precursor.

The flame spray pyrolysis conditions used for each sample are set out below in Table 4.

TABLE 4

| | | |
|---|---|---|
| Flame CH₄ | 1.5 | L/min |
| Flame O₂ | 3.2 | L/min |
| Sheath O₂ | 5 | L/min |
| Dispersion O₂ | 5 | L/min |
| Pressure drop | 1.5 | bar |
| Feed rate | 7.5 | ml/min |

In producing the samples, the lithium precursor, solvent mix, dopant precursor and dopant wt % were altered as shown in Table 5 below. The Co and Sn dopant precursors were selected for their solubility in the solvent systems used for the lithium and titanium precursors.

TABLE 5

| | Lithium | | Dopant | |
|---|---|---|---|---|
| Sample | Precursor | Dopant Precursor | wt % | Solvent |
| A | Li acetate | Co acetate | 5 | MeOH |
| | dihydrate | tetrahydrate | | |
| B | Li hydroxide | Co(acac)₂ | 5 | Xylene, acetonitrile, |
| | | | | acetic acid, EtOH |
| C | Li acetate | Co acetate | 10 | MeOH |
| | dihydrate | tetrahydrate | | |
| D | Li hydroxide | Co(acac)₂ | 10 | Xylene, acetonitrile, |
| | | | | acetic acid, EtOH |
| E | Li acetate | Sn acetate | 5 | MeOH |
| | dihydrate | | | |
| F | Li hydroxide | Sn | 5 | Xylene, acetonitrile, |
| | | 2-ethylhexanoate | | acetic acid, EtOH |
| G | Li acetate | Sn acetate | 10 | MeOH |
| | dihydrate | | | |
| H | Li hydroxide | Sn | 10 | Xylene, acetonitrile, |
| | | 2-ethylhexanoate | | acetic acid, EtOH |

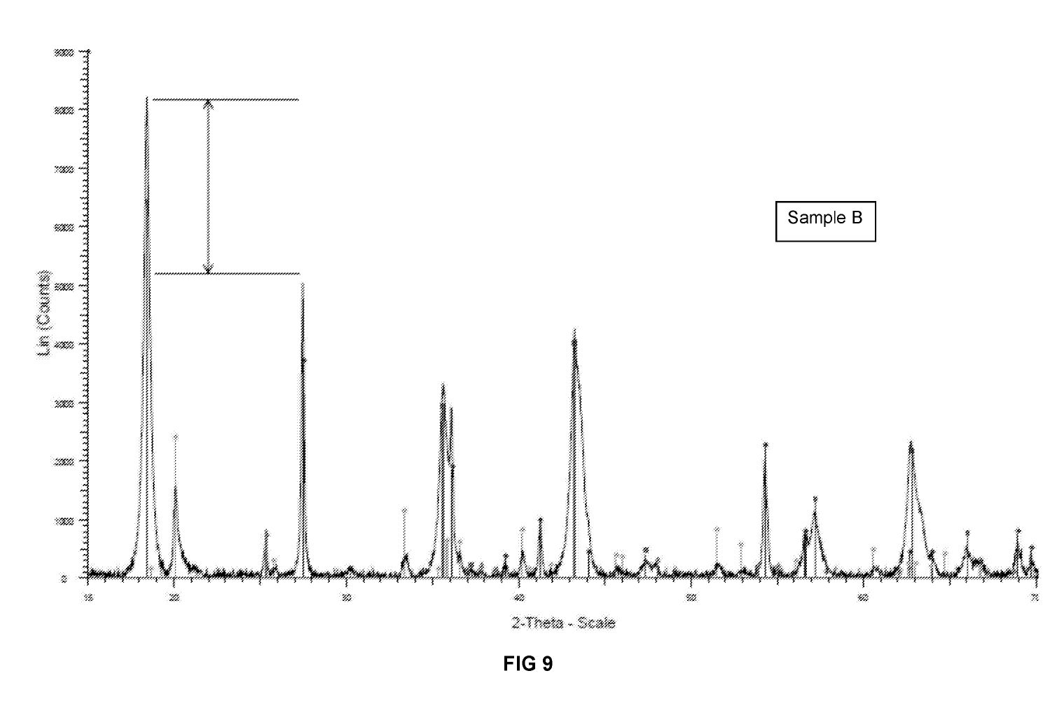

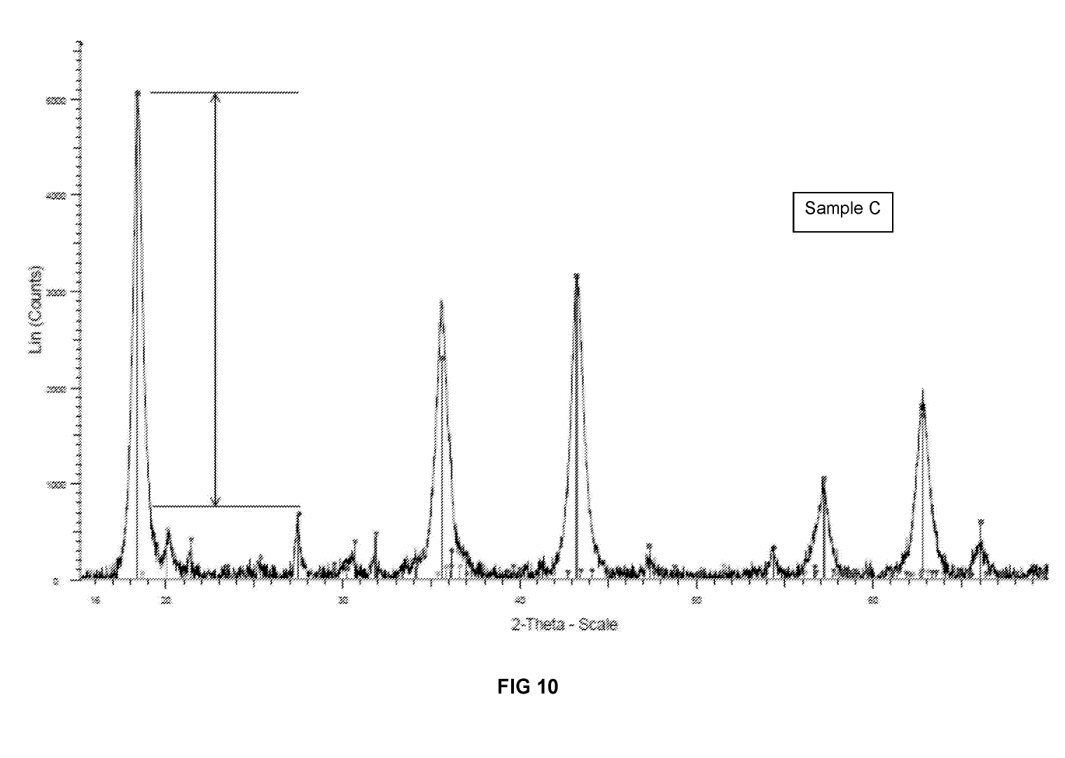

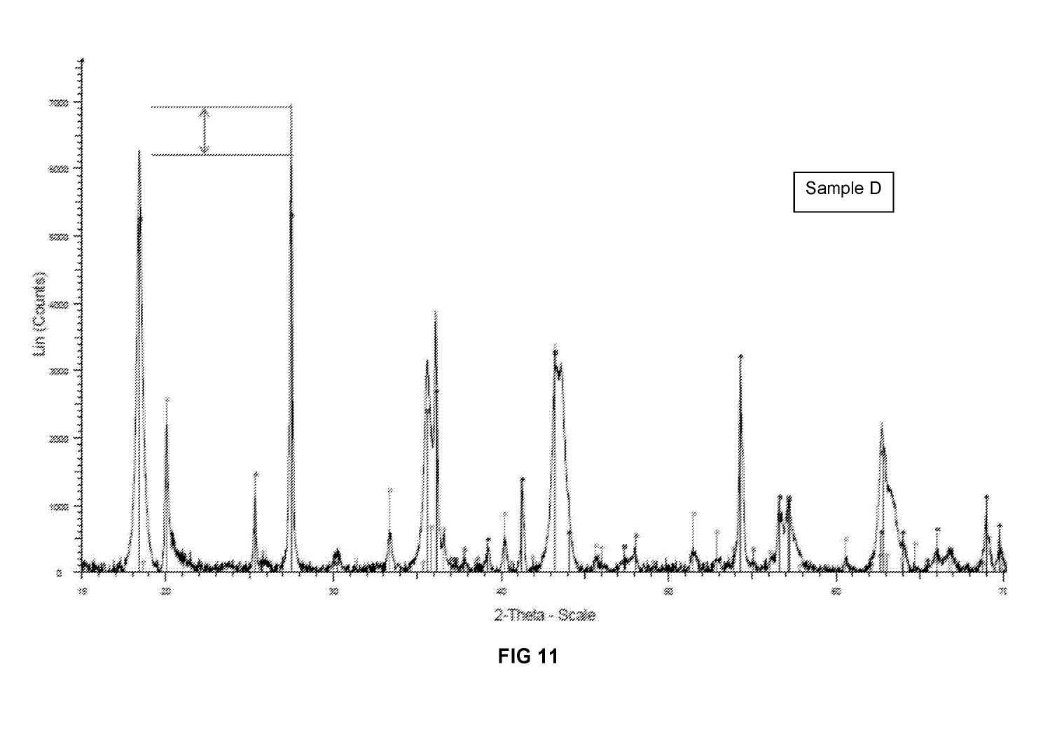

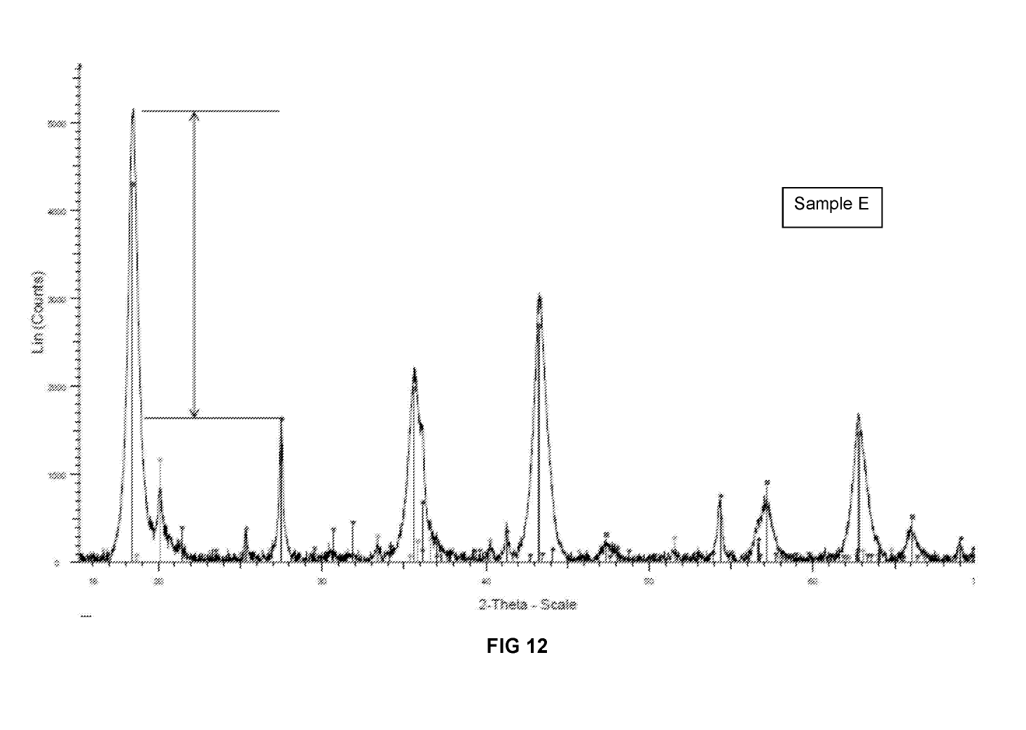

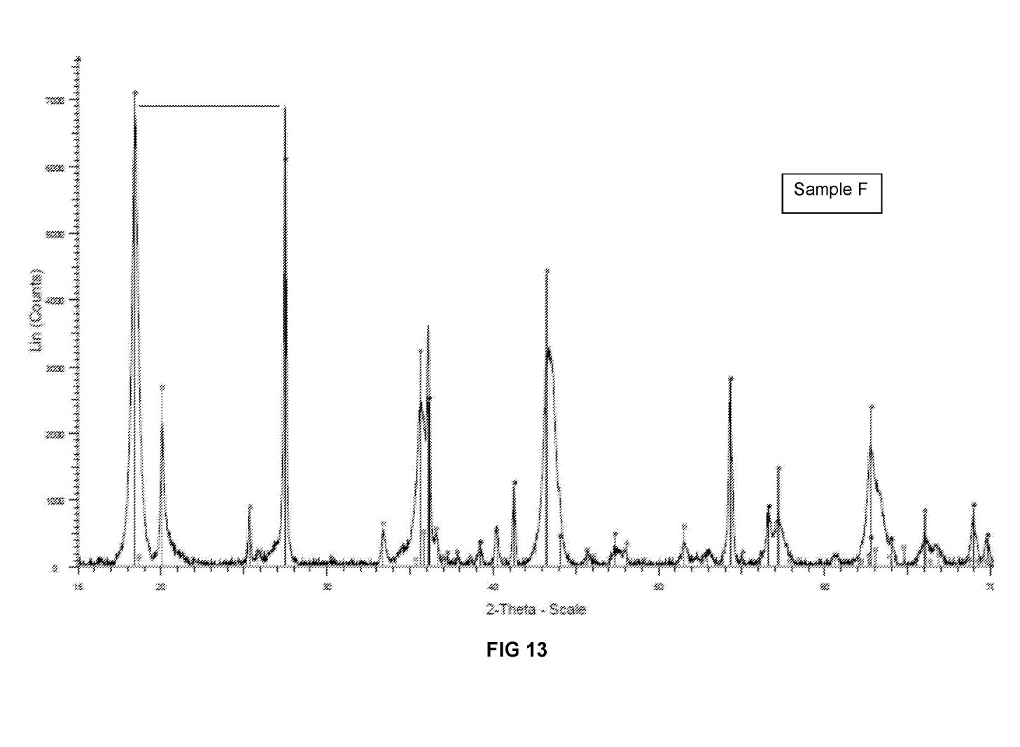

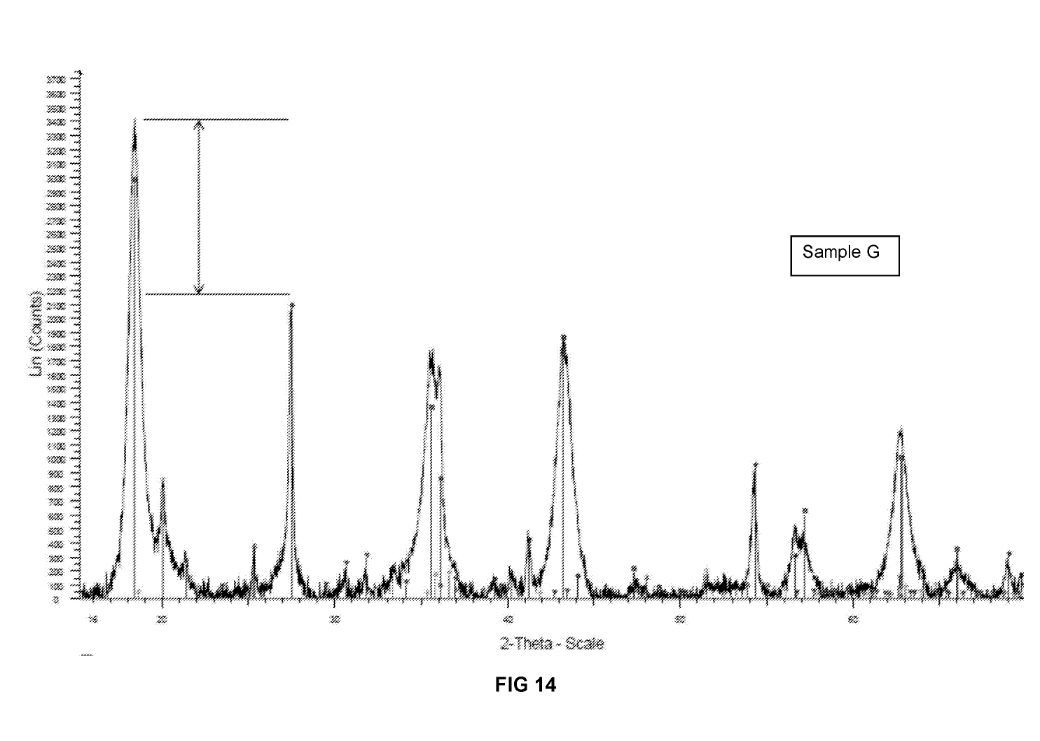

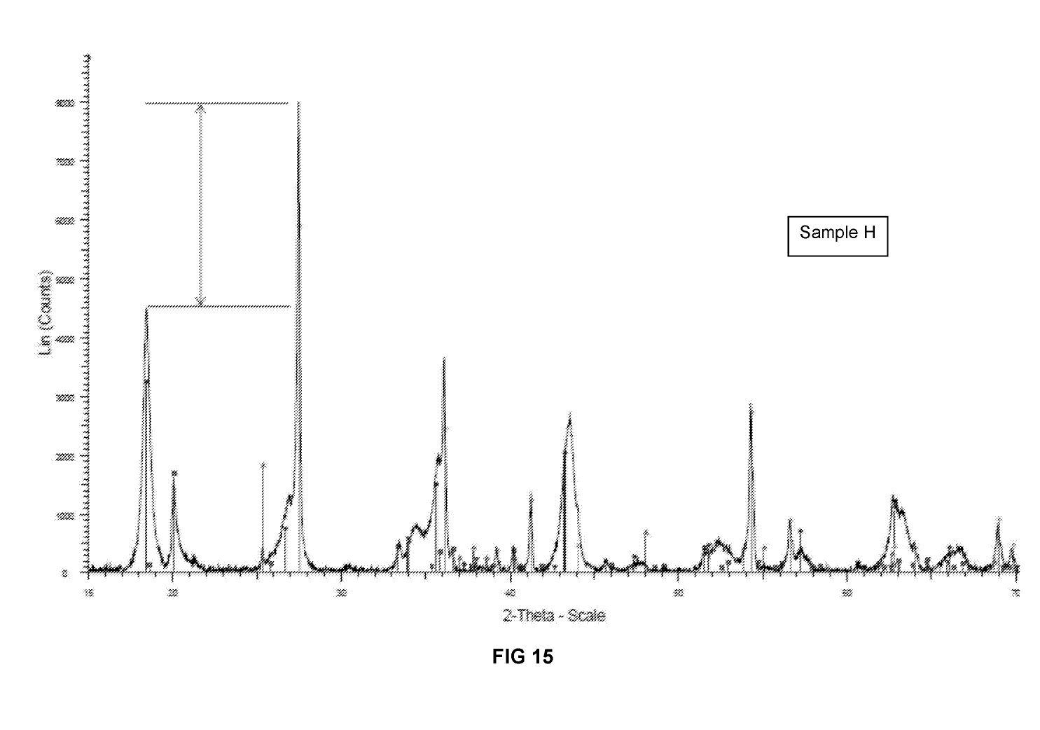

X ray diffraction was carried out on that samples produced to probe their composition. The results are shown in FIGS. 8 to 15. Comparing, for example, samples A and B, it can be seen that in the low melting point lithium precursor (lithium acetate) system, significantly less rutile phase is formed. In fact, the results suggest that inclusion of a dopant may increase the occurrence of the rutile phase—see for example samples F and H, which use the high melting point lithium precursor (lithium hydroxide). However, where the low meting point precursor is used (lithium acetate), the formation of rutile is suppressed even in doped systems.

The surface area of each sample is given in Table 6 below. The surface area was determined using the BET method, with N2 physisorption. The samples were degassed at 150° C. before measurement.

TABLE 6

| | Surface Area/ |
|---|---|
| Sample | m²/g |
| A | 129.9 |
| B | 69.95 |
| C | 125.7 |
| D | 63.07 |
| E | 123.4 |
| F | 70.98 |
| G | 115.4 |
| H | 65.10 |

Significantly higher surface areas are observed where the low melting point precursor is used, as shown in Table 6 below.

The work leading to this invention has received funding from the European Union Seventh Framework Programme under Grant Agreement No: 229036.

### REFERENCES

1. E. Ferg, R. J. Gummow, A. de Kock, M. M. Thackeray, Journal of the Electrochemical Society 141 (1994) L147-L150
2. K. M. Colbow, J. R. Dahn, R. R. Haering, Journal of Power Sources 26 (1989) 397-402
3. T. Ohzuko, A. Ueda, N. Yamamoto, Journal of the Electrochemical Society 142 (1995) 1431-1435
4. N. Zhang, Z. Liu, T. Yang, C. Lioa, Z. Wang, K. Sun, Electrochemistry Communications 12 (2011) 654-656
5. A. S. Prakasj, P. Manikandan, K. Ramesha, M. Sathiya, J.-M. Tarascon, A. K. Shukla, Chemistry of Materials 22 (2010) 2857-2863
6. L. Kavan, J. Prochazka, T. M. Spitler, M. Kalbac, M. Zukalova, T. Drezen, M. Gratzel, Journal of the Electrochemical Society 150 (2003) A1000-A1007
7. A. S. Arico, P. Bruce, B. Scrossati, J. M. Tarascon, W. van Schalkwijk, Nature Materials 4 (2005) 366-377
8. M. Armand, J.-M. Tarascon, Nature 451 (2008) 652-657
9. D. Bresser, E. Paillard, M. Copley, P. Bishop, M. Winter, S. Passerini, Journal of Power Sources 219 (1012) 217-222
10. T. Karhunen, A. Lande, J. Leskinen, R. Buchel, O. Waser, U. Tapper, J. Jokiniemi ISRN Naotechnology, Volume 2011, Article ID 180821

1-19. (canceled)

20. A method for the preparation of lithium titanate, wherein a precursor mixture comprising a solvent, a lithium precursor and a titanium precursor is subjected to flame spray pyrolysis to produce lithium titanate particles, wherein the lithium to titanium molar ratio provides titanium in stoichiometric excess.

21. The method according to claim 20 wherein the lithium precursor has a melting point of 200° C. or less.

22. A method for the preparation of lithium titanate, wherein a precursor mixture comprising a solvent, a lithium precursor and a titanium precursor is subjected to flame spray pyrolysis to produce lithium titanate particles, wherein the lithium precursor has a melting point of 200° C. or less.

23. A method according to claim 22 wherein the lithium to titanium molar ratio in the precursor mixture provides titanium in stoichiometric excess.

24. The method according to claim 20 wherein the lithium precursor is a lithium organometallic compound.

25. The method according to claim 24 wherein the lithium precursor compound is a lithium carboxylate or a lithium alkoxide, preferably lithium acetate dihydrate.

26. The method according to claim 20 wherein the titanium precursor has a melting point not more than 100° C. higher than the melting point of the lithium precursor compound.

27. The method according to claim 20 wherein the titanium precursor is a titanium coordination compound having alkoxy and/or carboxylate ligands, preferably titanium 2-ethylhexanoate.

28. The method according to claim 20 wherein the precursor mixture further comprises a dopant precursor.

29. A method for the preparation of doped lithium titanate, wherein a precursor mixture comprising a solvent, a lithium precursor, a titanium precursor and a dopant precursor is subjected to flame spray pyrolysis to produce doped lithium titanate particles, wherein the dopant precursor is a d or f block transition metal acetate compound, or a Group 13, 14 or 15 metal acetate compound.

30. The method according to claim 28 wherein the dopant precursor is a metal compound, such as a metal acetate.

31. The method according to claim 30 wherein the metal is Co or Sn.

32. A method according to claim 30, wherein the solvent comprises at least 50% v/v alcohol.

33. The method according to claim 28 wherein each of the lithium precursor, the titanium precursor and the dopant precursor, where present, is soluble in alcohol.

34. The method according to claim 20 further comprising forming the lithium titanate particles into an electrode or into a lithium ion conducting membrane.

35. The method according to claim 34 further comprising assembling a battery comprising said electrode or said lithium ion conducting membrane.

36. Doped lithium titanate particles having a surface area of at least 100m²/g, wherein the dopant is Co and/or Sn.

37. An electrode or lithium ion conducting membrane comprising doped lithium titanate particles as defined in claim 36.

38. A battery comprising an electrode or lithium ion conducting membrane as defined in claim 37.
